(19) United States
(12) Patent Application Publication
(10) Pub. No.: US 2015/0153717 A1
(43) Pub. Date: Jun. 4, 2015

(54) SYSTEM AND METHOD FOR ACCESSING INFORMATION USING OBJECTS

(71) Applicant: Richard Blair, Plaistow, NH (US)

(72) Inventor: Richard Blair, Plaistow, NH (US)

(73) Assignee: SCHNEIDER ELECTRIC INDUSTRIES SAS, Rueil Malmaison (FR)

(21) Appl. No.: 14/406,038

(22) PCT Filed: Jun. 7, 2012
(86) PCT No.: PCT/US2012/041315

§ 371 Date: Dec. 5, 2014

(51) Int. Cl. G05B 19/042

(52) U.S. Cl. CPC G05B 19/042

(57) ABSTRACT

A device, such as a HART multiplexer, may allow devices that communicate using the EtherNet/IP protocol or other protocols that support treating collections of data as objects to access one or more instruments. The devices may communicate with one or more object instances that each correspond to an instrument. These object instances may include data that corresponds to data that may be obtained from the underlying instrument. These object instances may be updated automatically, allowing requests for information in the object instances to be quickly fulfilled.

### CROSS REFERENCE TO RELATED APPLICATIONS

This application is related by subject matter to the following applications: PCT application number ______ (also identified by attorney docket number 500402.00594); PCT application number ______ (also identified by attorney docket number 500402.00596); and PCT application number ______ (also identified by attorney docket number 500402.00597). All of the above-mentioned patent applications are herein incorporated by reference and are being filed concurrently with the present application.

### BACKGROUND

Devices connected to an industrial network, such as a network with devices used in automation control or some other type of process control, may use various protocols to communicate with each other. Any one communication protocol may allow access to some data and/or devices throughout the network, but may not allow access to other data and/or devices. There is a need to improve the accessibility of instruments, including instruments that are based on the Highway Addressable Remote Transducer (HART) protocol.

### SUMMARY

According to one aspect of the disclosure, a device may maintain instances of one or more objects, such as Common Industrial Protocol (CIP) objects, that each correspond to an instrument, such as a HART instrument. Commands, such as HART commands, may be sent to the instrument in order to obtain data, which is then stored in an instance of an object. The data may then be accessed by reading the object instance instead of reading data from the underlying instrument. The data may be accessed using protocols such as EtherNet/IP, DeviceNet, or ControlNet.

According to another aspect of the disclosure, an object instance may be updated repeatedly and automatically, even when the data being updated has not been requested. An object instance may also be updated in response to a request.

According to a further aspect of the disclosure, updating an object instance may include checking a change counter of the underlying instrument and requesting additional information from the instrument only if the change counter indicates that the data of the instrument has been updated.

According to yet another aspect of the disclosure, each instance of an object may be assigned an instance number that corresponds to the channel on which the underlying instrument communicates. The instance number may also include a portion that corresponds to an address of the underlying instrument on the channel.

The preceding presents a simplified summary in order to provide a basic understanding of some aspects of the disclosure. The summary is not an extensive overview of the disclosure. It is intended neither to identify key or critical elements of the disclosure nor to delineate the scope of the disclosure. The summary merely presents some concepts of the disclosure in a simplified form as a prelude to the description below.

### BRIEF DESCRIPTION OF THE DRAWINGS

The present disclosure is illustrated by way of example and is not limited in the accompanying figures.

FIG. 1 illustrates an example of an industrial network in accordance with various aspects of the disclosure.

FIGS. 2 and 3 illustrate examples of objects that may be used to correspond to instruments in accordance with various aspects of the disclosure.

FIG. 4 illustrates two examples of outputs of a device that communicates with instruments in accordance with various aspects of the disclosure.

FIG. 5 illustrates an example of a method that a device may use to keep object instances that correspond to instruments up-to-date in accordance with various aspects of the disclosure.

FIG. 6 illustrates an example of a method that a device may use to respond to requests to access instances of objects that correspond to instruments in accordance with various aspects of the disclosure.

### DETAILED DESCRIPTION

In the following description reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

An industrial network may be used for a wide variety of purposes. Industrial networks are generally used to control or monitor industrial processes. For example, the amount of a fluid that is allowed into a mixing device may be controlled by actuating a valve in response to readings from one or more sensors. Industrial networks may be made up of any number of devices. These devices may be configured to communicate using various protocols, and the protocols may not be compatible with one another.

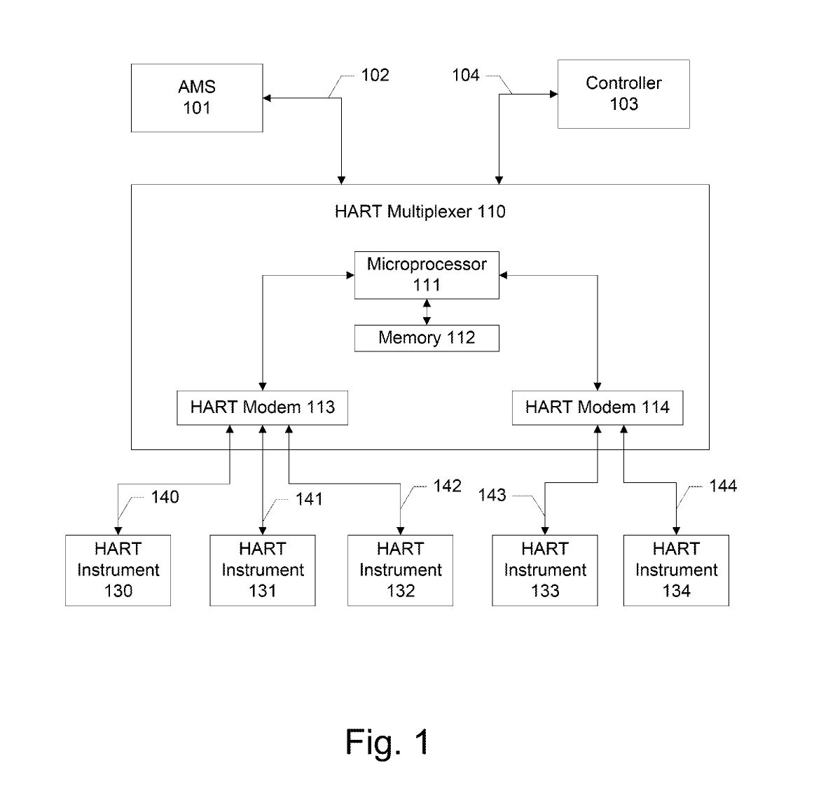

FIG. 1 illustrates an example of an industrial network. In this example, HART multiplexer 110 is in communication with HART instruments 130-134. Each HART instrument communicates with the HART multiplexer 110 using the Highway Addressable Remote Transducer (HART) protocol. This protocol allows for a single analog signal to be carried over a two-wire loop. Each of links 140-144 may be a two-wire loop. The analog signal values are represented by the current flowing through the two-wire loop, which ranges from 4 to 20 mA. Digital communications may be superimposed on the analog signal, allowing for additional data to be exchanged between each HART instrument 130-134 and the HART multiplexer 110. More than one instrument may be added to each two-wire loop. In this configuration, which is known as “multidrop mode,” all communications for the additional instruments occur digitally, and each instrument on the two-wire loop, which may be referred to as a “channel,” is typically given a unique address. Examples of HART instruments may include sensors, transducers, or any other device that communicates using the HART protocol.

Asset management software (AMS) 101 communicates with HART multiplexer 110. The asset management software may run on any computing device. Communications between AMS 101 and HART multiplexer 110 are illustrated by link 102. Communications over link 102 may take place using, for example, the Arcom protocol, which is a protocol designed for communicating with a HART multiplexer. The HART multiplexer 110 multiplexes signals from each HART instrument (130-134) onto communication link 102, thereby allowing asset management software 102 to communicate with each HART instrument 130-134 via a single communications link.

Asset management software is typically used to monitor the status of an industrial network. This often involves repeatedly checking the status of various sensors, valves, or other HART instruments. HART multiplexer 110 may help facilitate these checks by retrieving data from HART instruments automatically on an ongoing basis. By automatically retrieving data from HART instruments on an ongoing basis (which is sometimes referred to as “scanning”), the HART multiplexer may improve the speed with which it can provide data to the asset management software.

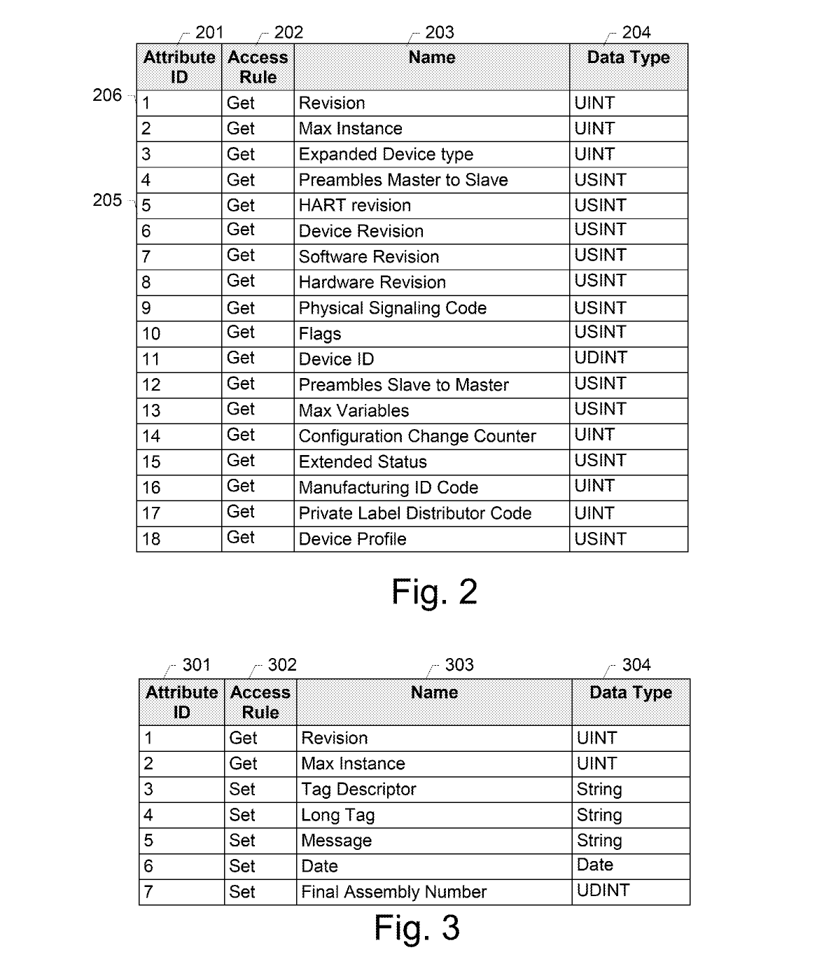

Controller 103 also communicates with HART multiplexer 110. Controller 103 may be any type of controller, such as, for example, a programmable logic controller. Communications between controller 103 and HART multiplexer 110 are illustrated by link 104. Link 104 may be, for example, an Ethernet link. Communications over link 104 may take place using, for example, the EtherNet/IP communications protocol. Other protocols may also be used, such as DeviceNet, ControlNet, etc. These protocols are not compatible with the HART protocol. Consequently, the HART multiplexer may translate requests from controller 103 into a HART message, send that message to a HART instrument, and translate the reply from the HART instrument into a message that controller 103 can understand. The HART multiplexer may also create and maintain instances of data objects that represent HART instruments. The objects may be, for example, Common Industrial Protocol objects. There may be at least one instance of an object for each connected HART instrument. This may allow controller 103, or any other device in the industrial network, to interact with HART instruments using the communications conventions of EtherNet/IP (or any other communications protocol that supports treating collections of data as objects). The HART multiplexer may also create and maintain one or more object instances that correspond to the HART multiplexer itself. Examples of objects that may correspond to HART instruments are discussed below with reference to FIGS. 2 and 3.

Many additional devices may be added to the industrial network illustrated in FIG. 1. For example, a human-machine interface may also communicate with HART multiplexer 110 in order to monitor and report information about the HART instruments. Instruments besides HART instruments may also exist on the network. These other instruments may, for example, communicate with controller 103 directly. Further, multiplexers for instruments that use a protocol other than HART may exist on the network. Also, more instances of each element shown in FIG. 1 may exist. For example, there may be more HART instruments than instruments 130-134. Also, there may be more than one HART multiplexer. Each HART multiplexer may be connected to the same AMS and the same controller. Alternatively, or in addition, additional controllers or additional AMS instances may be used. Additional alterations may also be made to the industrial network illustrated in FIG. 1. For example, controller 103 may be modified to include a multiplexer as one of its components. If HART multiplexer 110 is incorporated into controller 103, controller 103 may still include an Ethernet port for communications with other outside devices, such as instruments that communicate using protocols other than HART, other controllers, and other computing devices.

HART multiplexer 110 includes processor 111, which may be configured to receive messages from AMS 101, controller 103, HART modems 113-114, or any other devices. The software that configures processor 111 may be stored in memory 112. This software may include an operating system with applications running thereon. Memory 112 may also store other data, such as data read from HART instruments 130-134. Memory 112 may include read-only memory (ROM) and random access memory (RAM). Some or all of the software, memory, and microprocessor just described may also be embodied in an application specific integrated circuit (ASIC), a field programmable gate array (FPGA), or the like.

Each of the devices depicted in FIG. 1 may include one or more components, such as a processor, memory, and communications interface, similar to those shown for HART multiplexer 110.

FIG. 2 illustrates an example of a data object that corresponds to an instrument. Instances of the objects may be maintained by HART multiplexer 110 or any other device that acts as an intermediary between EtherNet/IP devices (or devices supporting other object-oriented protocols) and HART instruments (or instruments supporting any other protocol). Instances of the object illustrated in FIG. 2 may also be maintained by an instrument or a controller, such as Controller 103. Although instances of the object illustrated in FIG. 2 may correspond to a HART instrument, instances of the object may also be used for other types of instruments. For example, an object instance may be created that corresponds to a MODBUS instrument.

As seen in FIG. 2, an object may be structured to contain several elements of data. In this particular example, an object is used to represent most of the data that is available from a HART instrument upon issuing HART command 0. HART command 0 reads data from a HART instrument, but does not write data to the HART instrument. Consequently, as seen in column 202, each element of the object is accessed by a “get” access rule instead of a “set” access rule. Each data element may be identifiable by an attribute ID (as seen in column 201) and a name (as seen in column 203). In the example of FIG. 2, each element of the object is represented by an unsigned integer (“UINT”), an unsigned short integer (“USINT”) or an unsigned double integer (“UDINT”). Any other data type may also be used.

Although the example of FIG. 2 shows a HART object that closely resembles the data of a corresponding HART instrument, some objects that correspond to a HART instrument may alter the organization of the data that is received from the HART instrument. For example, some objects associated with a HART instrument, such as the one shown in FIG. 3, may contain a collection of data elements that do not correspond to any one HART command. Populating and updating the data elements of instances of such an object may require multiple HART commands.

Data element 205 corresponds to the HART revision number that is implemented by the corresponding HART instrument. (This may also be referred to as the version of the HART protocol that the HART instrument implements.) The data available from a HART instrument may vary depending on which HART revision it supports. For example the data available from a HART instrument using command 0 has grown over time, and it may grow further in the future. Therefore, some attributes of an object may not apply to all underlying instruments.

Later revisions of the HART protocol may allow for access to additional data compared to data that can be retrieved from the current revision of the HART protocol. Any additional data may be accommodated by defining new objects that include the additional data. These new objects may stand alone, or they may expand upon existing objects. Existing object definitions may also be revised to include additional data. Data element 206 of the object in FIG. 2 is named “Revision.” This attribute may represent the revision level of the object. When a new revision to the HART protocol becomes available, a revision to the corresponding object may also become available. The revised object may include more or different data items.

The additional data elements in the object of FIG. 2 include “Max Instance,” which indicates the highest instance number assigned to an instance of an object. For example, in FIG. 1, six instances of the object may exist—one for each of HART instruments 130-134 and one more if an instance is created to correspond to the HART multiplexer 110. Each of these instances will have a unique instance number, and “Max Instance” is set to the value of the highest of these six instance numbers.

The data element called “Configuration Change Counter” may increase each time any of the configuration information associated with the instrument is altered. The data elements referring to “Preambles” may indicate the size of the preamble that needs to be in each HART packet. Many of the other data elements provide additional details about an instrument or its status. Examples of such data elements include “Expanded device type,” “Device Revision,” “Software Revision,” etc.

Each HART instrument may be represented by instances of multiple different objects. An example of an additional data object that may correspond to a HART instrument (or another type of instrument) is shown in FIG. 3. In this object, note that columns 301-304 correspond to columns 201-204 of FIG. 2. However, in this object several of the attributes may be written to using a “set” access rule. Setting any of these attributes may result in data being written to the device represented by the object. The examples of FIGS. 2 and 3 are merely illustrative. A variety of additional objects may also be defined.

Some or all data elements in an object that corresponds to an instrument may not match any data element that can be read from the instrument. For example, a HART instrument may report one or more sensor readings, but a data element in an object may represent an interpretation of the sensor readings. For example, several sensors may be used to measure the depth of a liquid in a container. Readings from these sensors, as well as other information, may be synthesized to create a data element that represents the volume of liquid in the container. As seen in this example, data items in objects may be used to create abstractions of the data from the underlying instruments, thereby potentially reducing the complexity that must be handled by other devices. Although the above example involved reading from an object instance, other examples may involve other types of interactions. For example, writing to a single data element of an object instance may cause one or more data items to be written to an instrument.

Multiplexer 110 may continuously request data from connected instruments using a scan command. This allows multiplexer 110 to obtain up-to-date information about each instrument prior to that information being requested by an outside device. The process of scanning HART instruments is described in the patent application identified by Attorney Docket No. SAA-188 (402.00594), titled “Optimized Communications With HART Instruments,” which is herein incorporated by reference. This same scan may be used to keep instances of objects up-to-date. However, the need to update instances of objects may require that data beyond the data requested by the asset management software be retrieved as part of the normal scan command or commands. Further, it will be understood that instruments other than HART instruments may be scanned.

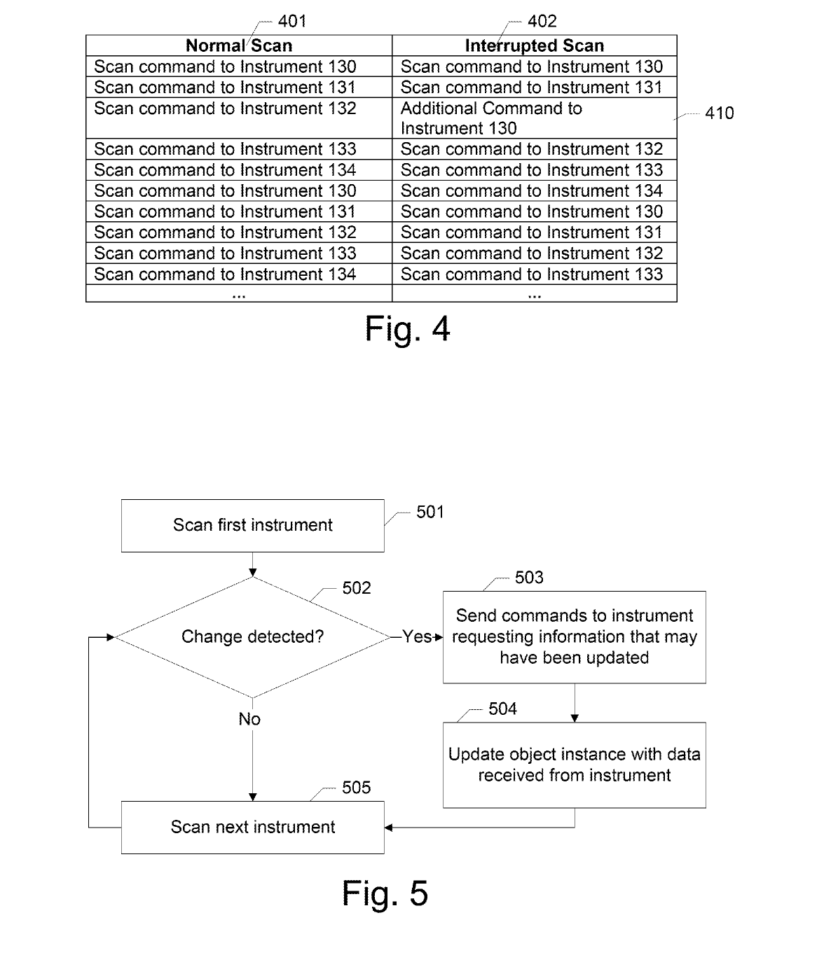

Two examples of outputs of that may result from scanning instruments to keep instances of objects up-to-date are illustrated in FIG. 4. A method that may generate the outputs of FIG. 4 is illustrated in FIG. 5. As illustrated in column 401 of FIG. 4, a normal scan command may be sent to each connected instrument repeatedly. The process of sending these normal scan commands is represented by steps 501 and 505 in FIG. 5.

An instrument may include a change counter, which is a number that is increased or otherwise changed each time any data in a certain set of data changes. For example, if any of the settings that determine the format in which an instrument outputs sensor readings is changed, then a configuration change counter may be increased. This change counter may be requested as part of the normal scan command or commands. Decision 502 in FIG. 5 represents detecting whether a change counter received from the instrument matches the change counter the multiplexer received previously. If the change counters match, then the normal scan may continue (step 505). If the change counter received from the instrument most recently does not match the previously-received change counter, then the data associated with the change counter has changed since the instrument was last scanned. Consequently, the process of FIG. 5 continues to step 503, where the multiplexer may interrupt its normal scan to send one or more additional commands to the instrument, as illustrated by element 410 in FIG. 4. The additional commands may be used to retrieve the data that may have triggered the change in the change counter of the instrument. Once this data has been received, the multiplexer may save the data it received, including the updated change counter, (step 504) and resume its normal scan cycle. The multiplexer may combine the additional commands that are to be inserted into the normal scan cycle with other commands, such as the normal scan commands. Further, the multiplexer may optimize this combined set of commands by identifying the set of data being requested by the combined set of commands and then identifying a set of commands that retrieves this set of data efficiently. Details of techniques for identifying a set of commands that retrieves a set of data efficiently are described in the patent application identified by Attorney Docket No. SAA-188 (402.00594), titled “Optimized Communications With HART Instruments.”

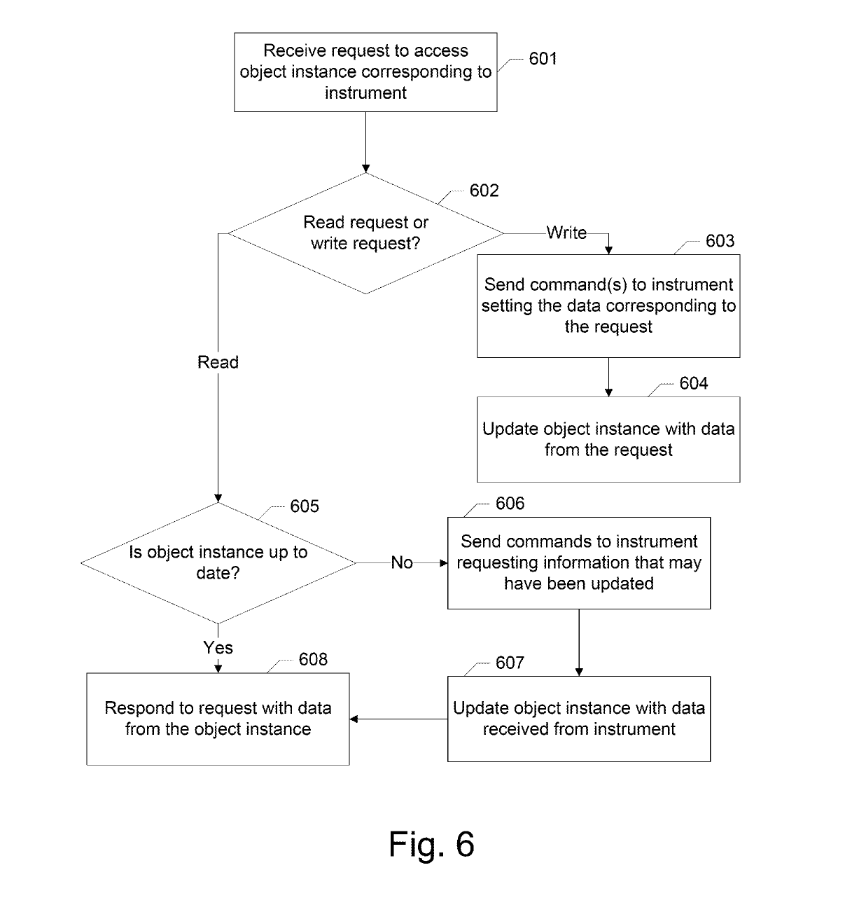

FIG. 6 illustrates a method for processing a request to access an instance of an object that corresponds to an instrument. The method may be performed by any device responsible for updating an object instance, including components included within an instrument (such as HART instrument 130), an intermediary (such as multiplexer 110), or components included within another device (such as controller 103). In step 601, a request to access the object instance is received. In step 602, whether the request is a read request or a write request is determined.

If the request is a write request, then the request is translated into one or more commands in step 603. These commands update the portions of the instrument that correspond to the data that is to be written to the instance of the object. For example, if the write request writes to a portion of an object that represents a variable's unit code (which is a code that indicates the format of a variable), then a command altering that variable's unit code will be sent to the instrument.

As indicated by step 604, the object instance that corresponds to the instrument is also updated with the new data. This keeps the object instance synchronized with the instrument. If the data that is written to an instrument is data that may cause a value of a change counter of the instrument to be updated, then the change counter of the object instance may be updated as well. The updated value of the change counter may be calculated automatically by the device performing the method. Alternatively or additionally, the updated value of the change counter may be retrieved from the instrument. Although the object instance may be updated without reading the values just written to the instrument back from the instrument, it may be preferable to update the object instance by reading the values from the instrument. This may help ensure that no errors occurred or that no further alterations to the instrument were made. In some embodiments, the object instance may be updated in step 604 using the same process that is described below for reading data from an object instance in steps 606 and 607.

If the request to access an object instance is a read request, then at step 605 the device performing the method determines whether the instance of the object is up-to-date. Instances of some objects may always be up-to-date. For example, instances whose values are updated as part of a normal scan cycle may always be considered up-to-date. Other instances of objects may be considered up-to-date if the last update of the instance occurred within a predetermined amount of time, such as 500 ms or 30 seconds. Further, the device performing the method may determine whether some instances are up-to-date by requesting a change counter from the instrument, as was described above. If the instance of the object is up-to-date, then the device performing the method may respond to the read request without sending a corresponding request to the instrument. Instead, the data already stored in the instance of the object may be used to respond to the request (step 608).

If the instance of the object is not up-to-date, then the instance may be updated prior to responding to the request. Some instances may never be considered up-to-date. These object instances may correspond to, for example, real-time readings from sensors. In step 606, commands are sent to the instrument requesting at least the information that is not up-to-date. In step 607, the information received from the instrument is used to update the instance of the object. Finally, in step 608, the device performing the method responds to the request with the requested data.

The method described above may be implemented differently in different devices. For example, in the network of FIG. 1, the request of step 601 and the response of step 608 may be sent between distinct devices, such as between multiplexer 110 and controller 103. But in a device where the instruments are directly connected to a controller, (such as a controller that includes a multiplexer), the request of step 601 may come from a portion of the controller's logic. Similarly, the response of step 608 may be sent back to that same portion of the controller's logic. In this example, the request generated in step 601 may come about as a result of inputs to the controller other than a response of the instrument from which data is being requested to a normal scan cycle.

The methods described above may help simplify the programming of devices that communicate using protocols other than the protocol of the instrument. For example, an EtherNet/IP request to get all of the information in a certain object instance or all of the information of a certain type may be issued. Requesting the information specified by the EtherNet/IP request from a HART instrument may require multiple commands, but the device requesting the information only needs to issue the single EtherNet/IP request.

The methods described above may also simplify the programming of devices because the devices may easily confirm that they are communicating information about the correct instrument by reading identifying information, such as the manufacturer's ID and product code, from the object instance. Further, the object instances may be identified using a numbering scheme that corresponds to the physical topology of the industrial network. For example, an instance that corresponds to multiplexer 110 may be assigned instance number 0. Another instance of the same object that corresponds to a first instrument may be assigned instance number 1. A third instance of the same object that corresponds to a second instrument may be assigned instance number 2, etc. Each instance number may correspond to the channel on which the multiplexer communicates with the corresponding instrument.

HART multiplexers that support HART's multi-drop mode may include additional information in the instance number. This is because multi-drop mode allows more than one HART instrument to exist on a single channel. Additional information may also be included in the instance number for other types of instruments that allow more than one instrument on a single channel. For example, the first eight bits of an instance number may represent the channel on which the multiplexer communicates with the corresponding instrument. The second eight bits of the instance number may represent the address of the instrument on the channel.

The methods described above may also speed data access because requests for data already cached in up-to-date object instances may be processed more quickly than the time it would take to retrieve the requested data from the instrument.

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, one of ordinary skill in the art will appreciate that the steps described above may be performed in other than the recited order, including concurrently, and that one or more steps may be optional in accordance with aspects of the disclosure. It will also be appreciated and understood that modifications may be made without departing from the true spirit and scope of the present disclosure. The description is thus to be regarded as illustrative instead of restrictive on the present disclosure.

What is claimed is:

1. A method comprising:
updating, at a first device, an instance of an object that corresponds to a Highway Addressable Remote Transducer (HART) instrument that is connected to the first device, wherein updating the instance of the object includes sending one or more HART commands to the HART instrument, receiving data from the HART instrument in response to the one or more HART commands, and saving at least some of the data received from the HART instrument in the instance of the object;
receiving, at the first device, a request from a second device to read at least a portion of the instance of the object; and
sending, from the first device to the second device, a response to the request, wherein the response contains at least a portion of the data that was received from the HART instrument and saved in the instance of the object.

2. The method of claim 1, further comprising:
sending a HART command that requests a change counter value of the HART instrument;
comparing the change counter value received from the HART instrument with data of the instance of the object that corresponds to the change counter; and
performing said updating of the instance of the object in response to determining that the change counter value received from the HART instrument does not match the data of the instance of the object that corresponds to the change counter.

3. The method of claim 2, wherein the first device performs said updating prior to receiving the request from the second device, and wherein the first device responds to the request from the second device by:
sending the HART command that requests said change counter value of the HART instrument to the HART instrument;
determining that the change counter value received from the HART instrument matches data that corresponds to the change counter that is saved in the instance of the object; and
sending said response to the request without sending further HART commands to the HART instrument.

4. The method of claim 1, wherein said updating of the instance of the object is performed in response to receiving said request from the second device.

5. The method of claim 1, wherein said instance of the object contains data that indicates a version of a HART protocol that the HART instrument supports.

6. The method of claim 1, further comprising:
receiving, at the first device, a request from the second device to write to the instance of the object; and
in response to receiving the request to write to the instance of the object, sending, from the first device to the HART instrument, one or more commands that write to the HART instrument data included in the request to write to the instance of the object.

7. The method of claim 1, further comprising:
maintaining, at the first device, an additional instance of the object, which corresponds to the first device.

8. The method of claim 1, further comprising:
updating, at the first device, a plurality of additional instances of the object, each of which corresponds to an additional HART instrument that is connected to the first device.

9. The method of claim 8, wherein each instance of the object that corresponds to a HART instrument has an identifier, wherein at least a portion of the identifier corresponds to a channel on which the first device is connected to said HART instrument.

10. The method of claim 9, wherein another portion of the identifier corresponds to an address of said HART instrument on said channel.

11. An apparatus comprising:
one or more Highway Addressable Remote Transducer (HART) communication interfaces, which are configured to connect to at least one HART instrument;
one or more other communication interfaces, at least one of which is configured to connect to a second device using a protocol other than the HART protocol;
a processor; and
a memory storing executable instructions that configure the apparatus to:
update an instance of an object that corresponds to a HART instrument, wherein updating the instance of the object includes sending one or more HART commands to the HART instrument, receiving data from the HART instrument in response to the one or more HART commands, and saving at least some of the data received from the HART instrument in the instance of the object;
receive a request to read at least a portion of the instance of the object from the second device; and
send, to the second device, a response to the request, wherein the response contains at least a portion of the data that was received from the HART instrument and saved in the instance of the object.

12. The apparatus of claim 11, wherein the instructions further configure the apparatus to:
send a HART command that requests a change counter value of the HART instrument;
compare the change counter value received from the HART instrument with data of the instance of the object that corresponds to the change counter; and
perform said update of the instance of the object in response to determining that the change counter value received from the HART instrument does not match the data of the instance of the object that corresponds to the change counter.

13. The apparatus of claim 12, wherein the instructions further configure the apparatus to perform said update prior to receiving the request from the second device, and wherein the instructions further configure the apparatus to respond to the request from the second device by:
sending the HART command that requests said change counter value of the HART instrument to the HART instrument;
determining that change counter value received from the HART instrument matches data that corresponds to the change counter that is saved in the instance of the object; and
sending said response to the request without sending further HART commands to the HART instrument.

14. The apparatus of claim 11, wherein the instructions configure the apparatus to perform said update of the instance of the object in response to receiving said request from the second device.

15. The apparatus of claim 11, wherein said object is a Common Industrial Protocol object and said instance of the object contains data that indicates a version of a HART protocol that the HART instrument supports.

16. The apparatus of claim 11, wherein the instructions further configure the apparatus to:
receive a request from the second device to write to the instance of the object; and
in response to receiving the request to write to the instance of the object, send, to the HART instrument, one or more commands that write to the HART instrument data included in the request to write to the instance of the object.

17. The apparatus of claim 11, wherein the instructions further configure the apparatus to maintain an additional instance of the object, which corresponds to the apparatus.

18. The apparatus of claim 11, wherein the instructions further configure the apparatus to update a plurality of additional instance of the object, each of which corresponds to an additional HART instrument that is connected to the apparatus.

19. The apparatus of claim 18, wherein each instance of the object that corresponds to a HART instrument has an identifier, wherein at least a portion of the identifier corresponds to the HART communication interface through which the apparatus is connected to said HART instrument.

20. A programmable logic controller comprising:
one or more communication interfaces, which are configured to connect to at least a first HART instrument;
one or more Ethernet ports;
a processor; and
a memory storing executable instructions that configure the programmable logic controller to:
update an instance of an object that corresponds to the first HART instrument, wherein updating the instance of the object includes sending one or more HART commands to the first HART instrument, receiving data from the first HART instrument in response to the one or more HART commands, and saving at least some of the data received from the first HART instrument in the instance of the object;
based on inputs to the programmable logic controller other than said data from the first HART instrument, generate a request to read at least a portion of the instance of the object; and
respond to the request by:
sending a HART command that requests a change counter of the first HART instrument;
comparing the change counter value received from the first HART instrument with data of the instance of the object that corresponds to the same change counter; and
reading at least a portion of the data that was received from the first HART instrument and saved in the instance of the object without sending further HART commands to the HART instrument if the change counter value received from the first HART instrument matches the data of the instance of the object that corresponds to the same change counter.
